(19) United States
(12) Patent Application Publication
(10) Pub. No.: US 2007/0252848 A1
(43) Pub. Date: Nov. 1, 2007

(54) Color conversion apparatus and color conversion method

(75) Inventor: Takayuki Sawada, Numazu-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/412,209

(22) Filed: Apr. 27, 2006

(51) Int. Cl. G09G 5/02

(52) U.S. Cl. 345/602

(57) ABSTRACT

The present invention generates a color conversion table which covers only a least minimum color gamut. Concretely, the invention has a color conversion table generating means for calculating a color gamut of a source color space based on a source device profile, when a color conversion table defined by a destination device profile is tabulated, in a color management module (CMM).

### BACKGROUND OF THE INVENTION

1. Field of the Invention

The present invention relates to a color conversion apparatus and color conversion method, which replace color conversion defined by a complex arithmetic equation or a multi-step operation with table interpolation to speed up operation.

2. Description of the Related Art

Conventionally, color conversion defined by a profile is composed of a multi-step operation as shown in FIG. 5, power multiplication is often used in a one-dimension curve, and the operation takes much time. To speed up operation, the final result of a series of operations is previously calculated and listed as a table, and color conversion is replaced with table interpolation (refer to FIG. 6).

FIG. 7 shows an example of address space of a destination color conversion table (projected on a plane), expressing an L*plane of L*a*b* color space. Intersections of the meshes correspond to table grid points. An irregular-shaped closed curve expresses a color gamut (source color gamut) of a source color space.

Conventionally, in destination color conversion, a color conversion table is generated by using the whole PCS color space (CIEXYZ or L*a*b*) as a definition area. In this case, a table including an area out of an input color gamut is generated, causing a problem that a memory for a color conversion table is wasted.

### BRIEF SUMMARY OF THE INVENTION

The object of an aspect of the present invention is to provide a color conversion apparatus and color conversion method, which decrease a waste of a memory for a color conversion table.

According to an aspect of the present invention, there is provided a color conversion apparatus comprising a color conversion table generating means for generating a color conversion table for converting a color signal of a device independent color space to a color signal of a second color space, based on characteristic information of a first color space and characteristic information of a second color space, and generating definition area information of the color conversion table; and a color conversion means for converting a color signal of the device independent color space to a color signal of the second color space, by referring to the color table and the definition area information of the color conversion table generated by the color conversion table generating means.

According to another aspect of the present invention, there is provided a color conversion method comprising generating a color conversion table for converting a color signal of a device independent color space to a color signal of a second color space, based on characteristic information of a first color space and characteristic information of a second color space, and generating definition area information of the color conversion table; and converting a color signal of the device independent color space to a color signal of the second color space, by referring to the generated color conversion table and definition area information of the color conversion table.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate preferred embodiments of the invention, and together with the general description given above and the detailed description of the embodiments given below, serve to explain the principles of an aspect of the invention.

FIG. 1 is a block diagram showing a basic configuration of a color management module (CMM) according to a color conversion apparatus of the invention;

FIG. 2 is a diagram showing a schematic configuration of a destination color conversion table generator/storage;

FIG. 3 is a graph for explaining a definition area of a destination color conversion table in a first embodiment;

FIG. 4 is a graph for explaining a definition area of a destination color conversion table in a second embodiment;

FIG. 5 is a diagram showing an example of a flow of color conversion defined by a profile;

FIG. 6 is a diagram showing a configuration example of speedup by conventional table interpolation; and

FIG. 7 is a graph for explaining a definition area of a conventional destination color conversion table.

### DETAILED DESCRIPTION OF THE INVENTION

An embodiment of the invention will be explained hereinafter with reference to the accompanying drawings.

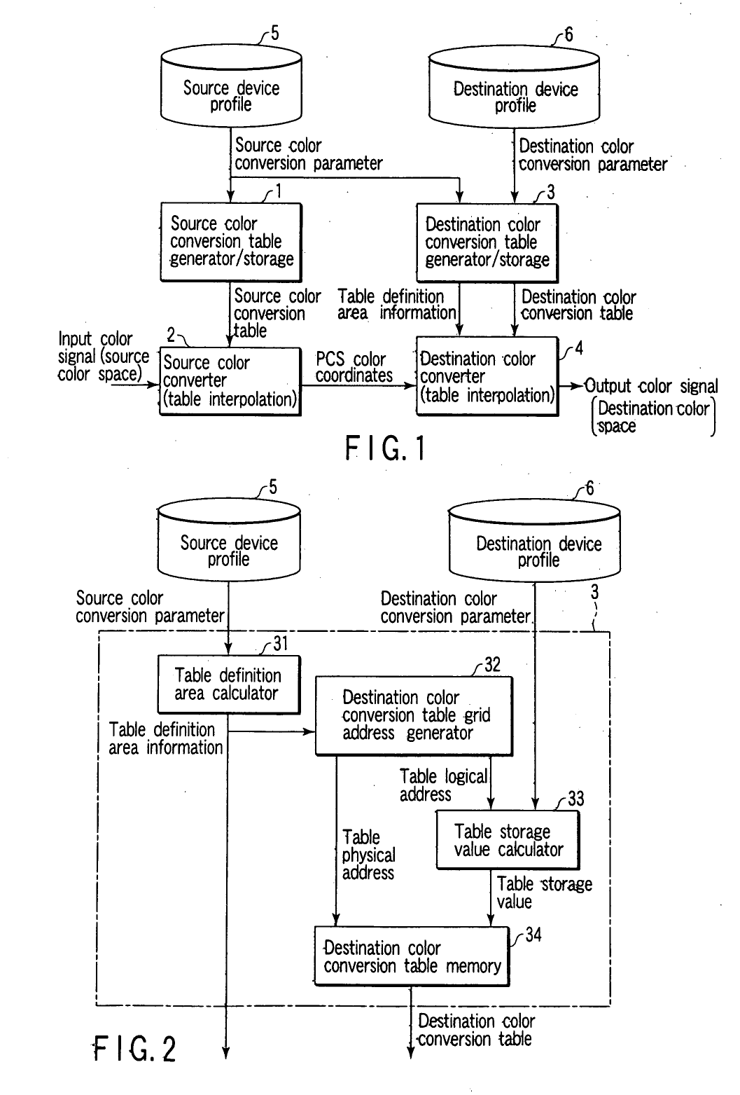

FIG. 1 shows a basic configuration of a color management module (CMM) according to a first embodiment of a color conversion apparatus of the invention. The CMM of FIG. 1 comprises a source color conversion table generator/storage 1, a source color converter 2, a destination color conversion table generator/storage 3, and a destination color converter 4.

The operation of the CMM shown in FIG. 1 will be explained by taking an example of color conversion from a sRGB color signal to a CMYK color signal of a certain printer P (not-shown).

First, a color profile is given as information necessary for color conversion. As a color profile, a source device profile is necessary as information of a color space of a color conversion source, and a destination device profile is necessary as information of a color conversion destination. In this example, a color profile of the sRGB color space corresponds to a source device profile 5, and a color profile of the CMYK color space of the printer P corresponds to a destination device profile 6.

In the CMM of the invention, the contents of a color profile defining a complex or multi-step operation is synthesized as one color conversion table and replaced by the table for speedup of the operation. The color conversion itself can be realized simply by interpolation by referring to the synthesized color conversion table.

The source color conversion table generator/storage 1 synthesizes and holds the contents of the source device profile 5 as one source color conversion table, and supplies it to the source color converter 2.

The source color converter 2 converts an input color signal (a color signal of a source color space) to the color coordinates of a profile connection space (PCS), which is the coordinate value of a color space uniquely defining a device-independent color, concretely indicating a CIEXYZ color space or L*a*b* color space) by interpolation by referring to the source color conversion table. In this example, the sRGB color signal is converted to the PSC color coordinate value.

The destination color conversion table generator/storage 3 synthesizes and holds the contents of a destination device profile 6 as one destination color conversion table, and supplies it to the destination color converter 4.

The destination color converter 4 converts the PCS color coordinate value to an output color signal (a color signal of a destination color space). In this example, the PCS color coordinate value is converted to the CMYK color signal of the printer P. Color conversion for one input is completed in this way.

The destination color conversion table generator/storage 3 is a characteristic component of the present invention.

FIG. 2 shows the internal configuration of the destination color conversion table generator/storage 3. The destination color conversion table generator/storage 3 comprises a table definition area calculator 31, a destination color conversion table grid address generator 32, a table storage value calculator 33, and a destination color conversion table memory 34.

In the CMM of the invention, when destination color conversion is tabulated, the destination color conversion table generator/storage 3 refers to a source profile, obtain a table definition area, and generates a table for that definition area. In this time, the table definition area calculator 31 converts the source color of the color coordinates of all peaks of a source color space, and defines a minimum rectangular solid (corresponding to the thick square frame in FIG. 7) involving a cube within the PCS color space with the resultant color coordinates (corresponding to the closed curve in FIG. 7), as a destination table definition area, by taking the cube in the PCS color space as a source color gamut.

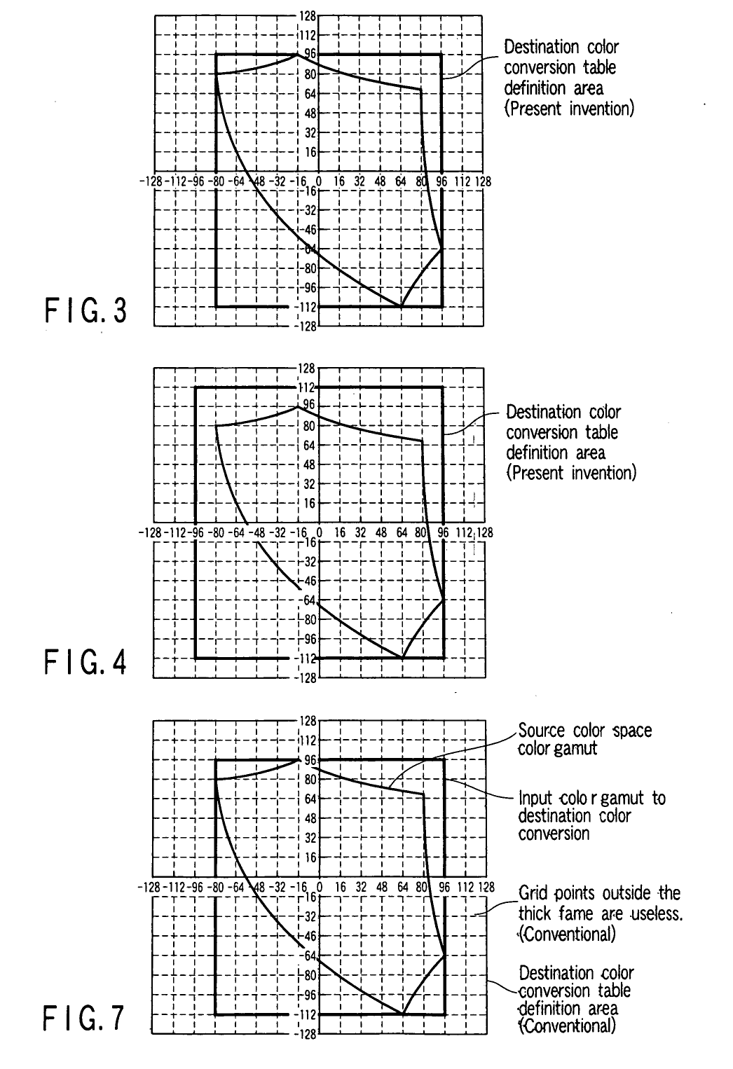

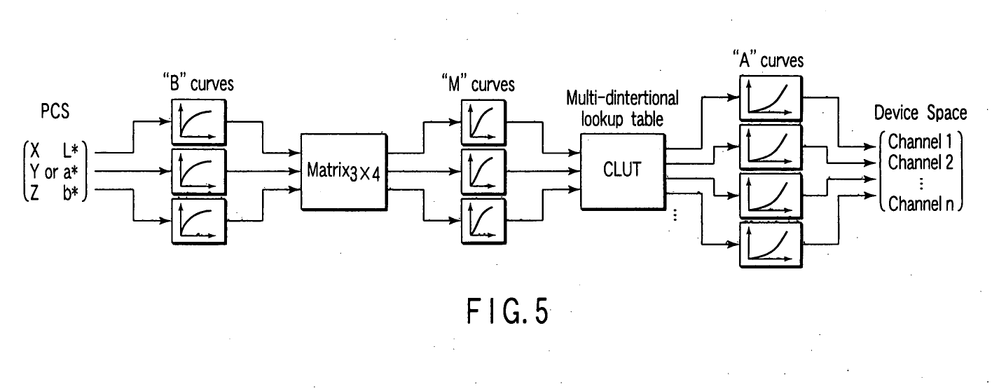

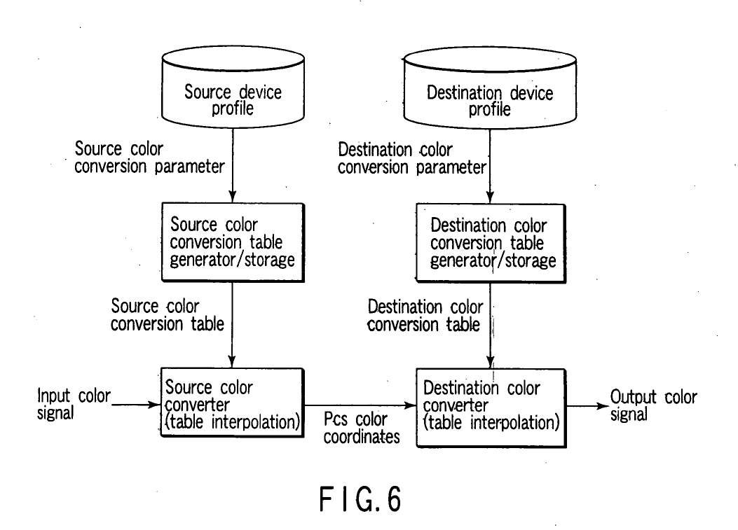

The destination color conversion table grid address generator 32 divides the obtained definition area equally in all of three directions (number of predetermined table grids per axis: 1) (refer to FIG. 3), and defines the PCS color coordinates of all intersections of the dividing boundaries as table grid points. Further, the table storage value calculator 33 converts the destination color of the table grid points, and stores the result in a table memory as a table value.

When the PCS color space is an L*a*b*color space, an origin point in an a*b*plane (L*axis in L*a*b* space) or an achromatic color value in the PCS color space does not usually coincide with the position of a table grid point, as shown in FIG. 3. In this case, when an achromatic color is input during the destination color conversion, a grid point of not a achromatic color is referred to for the table interpolation, and the result of achromatic color conversion shall originally be achromatic, but may be colored by the influence of an interpolation error.

To solve the problem, as in a second embodiment of the invention, the table definition area calculator 31 adjusts the definition area in the state as shown in FIG. 3, so that the grid point of the color conversion table is placed on the L*axis.

A concrete adjustment procedure will be explained hereinafter. In the following example, the upper and lower limit values of the destination color conversion table definition area are adjusted for one axis (hereinafter called a noticed axis) in the PCS color space, so that an achromatic color value coincides with a nearby grid point.

In the following example, the “number of grid points” indicates the number of grid points in the noticed axis direction, and the “achromatic color value” indicates the achromatic color value on the noticed axis. The “unadjusted position” indicates the position in the grid point space corresponding to an achromatic color value. The minimum value of the value indicating the position in the grid point space is 0, and the maximum value is (number of grid points—1). When the unadjusted position is not an integer, it indicates that the position is located between grid points. When the unadjusted position is an integer, it indicates that the position coincides a grid point. The “adjusted position” indicates the number of a coinciding grid point after the achromatic value is adjusted to coincide with a nearby grid point.

The “upper limit” and “lower limit” indicate the upper limit and lower limit values of a definition area before adjustment. The “adjusted lower limit” and “adjusted upper limit” indicate the upper limit and lower limit values of a definition area after adjustment. ROUND (x, 0) indicates rounding off all digits to the right of the decimal point of x. ROUNDDOWN (x, 0) indicates rounding down all digits to the right of the decimal point of x. ROUNDUP (x, 0) indicates rounding up all digits to the right of the decimal point of x. ABS (x) indicates an absolute value of x.

First, calculate an adjusted position of a achromatic color value by using the following procedure.

if (unadjusted position == 0) {

adjusted position = 0;

} else {
if (unadjusted position == (number of grid point −
1)) {
adjusted position = (number of grid points −1)
} else {
if (ROUND (unadjusted position, 0) == 9) {
adjusted position = 1;
} else {
if (ROUND (unadjusted position, 0) == (number of
grid points −1)) {
adjusted position = number of grid points −2;
} else {
if (ABS (achromatic color value − upper limit) <
ABS (achromatic color − lower limit))
adjusted position = ROUNDDOWN (unadjusted
position, 0);
} else {
adjusted position = ROUNDUP (unadjusted position,
0)
}

Next, calculate the upper and lower limits of a definition area by using the following procedure, and complete the adjustment.

if (ABS (achromatic color value − upper limit) < <
< ABS (achromatic color value − lower limit)) {
adjusted upper limit = (achromatic color value −
lower limit) * (number of grid points −1 −
adjusted position)/adjusted position + achromatic
color value;
adjusted lower limit = lower limit;
} else {
adjusted upper limit = upper limit;
adjusted lower limit = (achromatic color value −
upper limit) * adjusted position/(number of grid
points −1 − adjusted position) + achromatic color
value;
}

As explained hereinbefore, according to the embodiments of the invention, all table grid points are allocated within a source color gamut as shown in FIG. 3, and a table interpolation error is decreased when wasted memory is decreased. Namely, by generating a color conversion table which covers only a least minimum color gamut, waste of memory for the color conversion table can be prevented, and the color conversion accuracy can be improved by allocating memory resources given more to an input color gamut.

According to the second embodiment, when the PCS color space is L*a*b*color space, the grid point of the color conversion table is put on the L*axis, and when an achromatic color is input as an object of color conversion, only a grid point on the L*axis (i.e., an achromatic color) contributes to actual color conversion. Therefore, the color conversion result is not influenced by a surrounding chromatic color (not colored), and output as an achromatic color.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A color conversion apparatus comprising:
a color conversion table generating means for generating a color conversion table for converting a color signal of a device independent color space to a color signal of a second color space, based on characteristic information of a first color space and characteristic information of a second color space, and generating definition area information of the color conversion table; and
a color conversion means for converting a color signal of the device independent color space to a color signal of the second color space, by referring to the color conversion table and definition area information of the color conversion table generated by the color conversion table generating means.

2. The color conversion apparatus according to claim 1, wherein the color conversion table generating means has a color conversion table definition area calculating means for calculating a rectangular solid area in the device independent color space circumscribing a color gamut of the first color space based on the characteristic information of the first color space, and outputting the rectangular solid area information as definition area information of the color conversion table;
a color conversion table grid address generating means for generating a color signal limited within the definition area of the device independent color space as a color conversion table grid address, based on the definition area information of the color conversion table output from the color conversion table definition area calculating means; and
a table storage value calculating means for calculating a color conversion table storage value by applying the characteristic information of the second color space to the color conversion table grid address generated by the color conversion table grid address generating means.

3. The color conversion apparatus according to claim 2, wherein the color conversion table definition area calculating means outputs a larger rectangular solid area involving the rectangular solid circumscribing the color gamut of the first color space, under a predetermined number of color conversion table grids, so that one of groups of color conversion table grid address of a plurality of series arranged parallel to an achromatic color axis in the device independent color space is placed on the achromatic color axis.

4. A color conversion apparatus comprising:
a color conversion table generating means for generating a color conversion table for converting a color signal of an L*a*b* color space to a color signal of a second color space, based on characteristic information of a first color space and characteristic information of a second color space, and definition area information of the color conversion table; and
a color conversion means for converting a color signal of the L*a*b* color space to a color signal of the second color space, by referring to the color table and definition area information of the color conversion table generated by the color conversion table generating means.

5. The color conversion apparatus according to claim 4, wherein the color conversion table generating means has a color conversion table definition area calculating means for calculating a rectangular solid area in the L*a*b* color space involving a color gamut of the first color space based on the characteristic information of the first color space, and outputting the rectangular solid area information as definition area information of the color conversion table;
a color conversion table grid address generating means for generating a color signal limited within the definition area of the L*a*b* color space as a color conversion table grid address, based on the definition area information of the color conversion table output from the color conversion table definition area calculating means; and
a table storage value calculating means for calculating a color conversion table storage value by applying the characteristic information of the second color space to the color conversion table grid address generated by the color conversion table grid address generating means.

6. The color conversion apparatus according to claim 5, wherein the color conversion table definition area calculating means makes adjustment in one of the a* and b* directions in the L*a*b* space, depending on the distance between an upper limit value of a color gamut of the first color space and an achromatic color value (a*=0 or b*=0) and the distance between a lower limit value of a color gamut of the first color space and an achromatic color value, based on the rectangular solid area circumscribing a color gamut of the first color space, the color conversion table definition area calculating means adjusts only the upper limit value to a larger value when the distance between the upper limit value and achromatic color value is smaller, so that a value indicating a position in a color conversion table grid address space corresponding to the achromatic value is an integer value obtained by rounding down all digits to the right of the decimal point of an original value; and adjusts only the lower limit value to a smaller value when the distance between the upper limit value and achromatic color value is larger, so that a value indicating a position in a color conversion table grid address space corresponding to the achromatic value is an integer value obtained by rounding up all digits to the right of the decimal point of an original value.

7. A color conversion method comprising:
generating a color conversion table for converting a color signal of a device independent color space to a color signal of a second color space, based on characteristic information of a first color space and characteristic information of a second color space, and generating a definition area information of the color conversion table; and
converting a color signal of the device independent color space to a color signal of the second color space, by referring to the generated color conversion table and definition area information of the color conversion table.

8. The color conversion method according to claim 7, further comprising:
calculating a rectangular solid area in the device independent color space circumscribing a color gamut of the first color space based on the characteristic information of the first color space, and outputting the rectangular solid area information as definition area information of the color conversion table;
generating a color signal limited within the definition area of the device independent color space as a color conversion table grid address, based on the definition area information of the color conversion table; and
calculating a color conversion table storage value by applying the characteristic information of the second color space to the color conversion table grid address.

9. The color conversion method according to claim 8, wherein the definition area information of the color conversion table is information of a larger rectangular solid area involving the rectangular solid circumscribing the color gamut of the first color space, under a predetermined number of color conversion table grids, so that one of groups of color conversion table grid address of a plurality of series arranged parallel to an achromatic color axis in the device independent color space is placed on the achromatic color axis.

10. A color conversion method comprising:
generating a color conversion table for converting a color signal of an L*a*b* color space to a color signal of a second color space, based on characteristic information of a first color space and characteristic information of a second color space, and definition area information of the color conversion table; and
converting a color signal of the L*a*b* color space to a color signal of the second color space, by referring to the generated color conversion table and definition area information of the color conversion table.

11. The color conversion method according to claim 10, further comprising:
calculating a rectangular solid area in the L*a*b* color space involving a color gamut of the first color space based on the characteristic information of the first color space, and outputting the rectangular solid area information as definition area information of the color conversion table;
generating a color signal limited within the definition area of the L*a*b* color space as a color conversion table grid address, based on the definition area information of the color conversion table; and
calculating a color conversion table storage value by applying the characteristic information of the second color space to the color conversion table grid address.

12. The color conversion method according to claim 11, wherein the definition area information of the color conversion table makes adjustment in one of the a* and b* directions in the L*a*b* space, depending on the distance between an upper limit value of a color gamut of the first color space and an achromatic color value (a*=0 or b*=0) and the distance between a lower limit value of a color gamut of the first color space and an achromatic color value, based on the rectangular solid area circumscribing a color gamut of the first color space, the definition area information of the color conversion table adjusts only the upper limit value to a larger value when the distance between the upper limit value and achromatic color value is smaller, so that a value indicating a position in a color conversion table grid address space corresponding to the achromatic value is an integer value obtained by rounding down all digits to the right of the decimal point of an original value; and adjusts only the lower limit value to a smaller value when the distance between the upper limit value and achromatic color value is larger, so that a value indicating a position in a color conversion table grid address space corresponding to the achromatic value is an integer value obtained by rounding up all digits to the right of the decimal point of an original value.
